(19) United States
(12) Patent Application Publication
(10) Pub. No.: US 2007/0143679 A1
(43) Pub. Date: Jun. 21, 2007

(54) Virtual character with realtime content input

(75) Inventor: Benjamin I. Resner, Roxbury, MA (US)

Correspondence Address: CHARLES G. CALL, 68 HORSE POND ROAD, WEST YARMOUTH, MA, 02673-2516, US

(73) Assignee: Ambient Devices, Inc., Cambridge, MA (US)

(21) Appl. No.: 11/704,136

(22) Filed: Feb. 8, 2007

Related U.S. Application Data
(63) Continuation-in-part of application No. 10/247,780, filed on Sep. 19, 2002.
(63) Continuation-in-part of application No. 11/149,929, filed on Jun. 10, 2005.
(63) Continuation-in-part of application No. 10/247,780, filed on Sep. 19, 2002.
(60) Provisional application No. 60/578,629, filed on Jun. 10, 2004.

(51) Int. Cl. G06F 3/00

(52) U.S. Cl. 715/706; 706/931

(57) ABSTRACT

An interactive virtual character which represents a real or imagined human or animal having perceptible attributes that are interactively varied by a processor in response data acquired from command accepted from a user as well as by data received from a remote source that is broadcast via a wireless data network. In the preferred embodiment, commands from the user select articles of clothing to be worn by the virtual character and the processor causes the virtual character to smile if the user-selected clothing is suitable for the weather specified by the data received from the remot source, and to frown if the selections are not suitable.

### CROSS REFERENCE TO RELATED APPLICATIONS

This application is a continuation in part of U.S. patent application Ser. No. 10/247,780 filed on Sep. 19, 2002 now Application Publication No. 2003/0076369. This application is also a continuation in part of U.S. patent application Ser. No. 11/149,929 filed on Jun. 10, 2005 which is a non-provisional of U.S. Provisional Patent Application Ser. No. 60/578,629 filed on Jun. 10, 2004. This application claims the benefit of the filing date of each of the foregoing applications and incorporates their disclosures herein by reference.

### FIELD OF THE INVENTION

This invention relates to electronically controlled virtual characters representing real or imagined humans or animals that are rendered as graphical images or movable mechanisms.

### BACKGROUND OF THE INVENTION

Ambient Devices of Cambridge, Mass. operates a wireless network that transmits terse data at very low data rates to remote devices that provide information to users. The “Ambient Orb,” an example of these devices, is a glass lamp that uses color to provide weather forecasts, trends in the stock market, or the level of traffic congestion to expect for a homeward commute. For example, the Orb may display stock market data from the network by glowing red green or red to indicate market movement up or down, or yellow when the market is calm.

The Ambient Information Network is described in the above-noted patent application 2003/0076369. One of the products from Ambient that uses this network is the five-day weather forecaster, which receives content from AccuWeather™ via the Ambient servers. The weather forecaster, as described in the above-noted U.S. patent application Ser. No. 11/149,929, receives and weather forecast specific to a given location and provides forecasts for a full five days or longer. Traditional weather stations employ a local barometer and use this to infer weather patterns for the next 12 hours.

The preferred embodiments of the present invention use data simulcast over this low speed wireless data network to control interactive “virtual characters” that can provide information, recreation, training and entertainment to users.

Virtual Characters

As used herein, the term “virtual characters” refers to electronically controlled representations of real or imagined human or animal forms embodied in physical form, such as a animatronic stuffed animal, or rendered as an image on a display screen. Virtual Characters are often interactive and are typically controlled by a rules-based state machine that determines the virtual character's behavior. Virtual characters may be used to provide information, entertainment, training, or as a research tool.

A block diagram of a typical virtual character rendered as a graphical image is shown in FIG. 1. All virtual characters include an internal state machine 105 that determines the behavior of the character. The state machine 105 will typically consist of a set of rules that determine how inputs are mapped to outputs. In a very simple implementation these rules are rigid—for example the virtual character will eat every time food is put in front of it. More complex implementations take history into account—for example the virtual character will only eat food in front of it if it has not already eaten in the past hour. In this case, the state machine must include a timekeeping mechanism (the clock 104). There is no upper limit to the possible complexity of these rules. Some state machines include complex learning that will take into account events that happened long ago, or make complex correlations between two different events to determine if the food will be eaten or not. For example, the virtual character could take into account the reputation of the entity presenting the food. State machines with this amount of complexity typically also include persistent storage 106 to maintain state between sessions.

The inputs to this state machine are typically very well defined. Customary inputs include a user interface 102 that can include buttons, keyboard, mouse-action, touch-sensitive screens, and other electronic transducers that convert physical impulses into electronic signals that can be understood by the state machine. Most behavioral state machines also include some amount of randomness, typically provided by a random number generator 103, so the behavior does not appear overly predictable and mechanistic. For example, a state machine could decide that a character eats food 90% of the time. Users often find this small amount of unpredictability to create a character that is more believable than a character with 100% predictability.

The output of a state machine in its simplest form is a set of numbers and/or text strings. Most users do not find this interesting. Therefore, the output of the state machine is typically rendered in a form more pleasing to humans. These include a high or low-resolution display screen 110 and audio speaker(s) 111. Other possible outputs include motors that control the mechatronic output of a physical representation of the virtual character. The rendering of virtual characters of often extremely complex and can employ sophisticated graphics and audio renderers 108 and 109 to make the virtual character appear as real as possible. These renderers can surpass the complexity of the state machine.

More modern versions of virtual characters allow different instances to communicate with each other. This can be via a short-range infrared (IR) or radio frequency (RF) communications link, or over a long-range network such as TCP/IP. The state machine of a virtual character that can be connected to another virtual character includes the capacity to input the state of a remote virtual character as seen at 101, and to transfer state information to another peer as seen at 107. Generally this communication is symmetrical, but it is certainly possible that some virtual characters only input state, while others exclusively output state. Sometimes the purpose of this linkage is to permit communicating virtual characters to compete with one another in a game or fight that one character can win while another loses.

Some representative implementations of virtual characters that illustrate the concept are described below.

The Tamagotchi™ marketed by Bandai of Tokyo, Japan is a self-contained portable virtual pet that require the user to administer feeding, grooming, and other pre-defined nurturing activities at specified times in order to maintain health. The goal of Tamagotchi is to keep the virtual pet alive for as long as possible. Proper care and feeding in accordance with the state machine allow the pet to live longer. Tamagotchi's are designed to be carried with the user so care can be administered whenever necessary. Tamagotchi's include a battery, speaker, a low-resolution LCD screen for display, and buttons for user input. Newer version of Tamagotchis include a wireless link allowing groups of Tamagotchis to interact with each other via a RF or IR link.

The Synthetic Characters group at the MIT Media Lab in Cambridge, Mass. used models of animal behavior as an inspiration for creating intelligent systems. Animals are very successful at learning behaviors that help them survive. By imitating these mechanisms in a virtual environment, the hope is that computers can learn similarly clever and effective means to solve problems. The Synthetic Characters group built several interactive virtual characters where the state machine driving the behavior was modeled on actual animal behavior elements such as classical and operant conditions. The hope is to build a virtual character with believable behaviors from a bottom-up approach. See “Integrated Learning for Interactive Synthetic Characters” by B. Blumberg et al., Proceedings of the 29th annual conference on Computer graphics and interactive techniques, SIGGRAPH 2002 and “New Challenges for Character-based AI for Games” by D. Isla and B. Blumberg in Proceedings of the AAAI Spring Symposium on AI and Interactive Entertainment, Palo Alto, Calif., March 2002.

Virtual characters called Dogz™, Catz™, Petz™ marketed by PF. Magic of San Francisco, Calif. are implemented by software installed on a PC or Macintosh computer. Upon activation of the software, the user is prompted to adopt a dog and/or cat of his or her choice. Various interface elements allow the user to interact with the virtual dog or cat on the computer screen and do actions such as give food or throw a ball. Over time the pet ages from a puppy or kitten into an adult dog or cat. NeoPets™ from NeoPets, Inc. (www.neopets.com) are similar to DogZ™ and Catz™ except the virtual pets are web based. No software is required to be installed on the user computer, and the user can interact with his or her pets via any web-enabled computer. Aquazone™ from SmithMicro Software of Aliso Viejo, Calif. is software similar to DogZ™ and Catz™, except the habitat is a fish tank. Users maintain a virtual fish tank and are required to care and feed for the virtual fish.

Dress ElMO™ for Weather by Children's Television Workshop of New York, N.Y. is a virtual character that represents Elmo, a popular television character featured on Sesame Street™. The Children's Television Workshop website includes an activity that allows children to pick a weather scenario (sunny, snowy, windy, rainy), and then pick out the appropriate clothing for that day. Elmo responds approvingly if he has been dressed appropriately, and suggests an alternative wardrobe if he is dressed incorrectly for the chosen weather conditions. Elmo also reacts to the incorrect weather by shivering or sweating.

### SUMMARY OF THE INVENTION

The following summary provides a simplified introduction to some aspects of the invention as a prelude to the more detailed description that is presented later, but is not intended to define or delineate the scope of the invention.

The preferred embodiment of the invention take the form of an improvement in interactive virtual characters of the type including an input device for accepting input command data from a user and a display screen for producing a graphical image representing a real or imagined human or animal whose displayed behavior varies in response the input command data, wherein the improvement employs controls the virtual character in response to data received via a wireless data transmission network that repetitively broadcasts update messages that contain the current values of one or more variable quantities, the update messages being broadcast to a plurality of different wireless data receivers each of which is located remotely from said information server and each of which includes a wireless data receiver and a decoder for receiving the update messages and extracting selected ones of said current values from said update messages. A cache memory in the improved virtual character is coupled to the input device and to the decoder in one of said data receivers, and stores input command data from the user and selected ones of said current values extracted form said update messages. A processor coupled to the cache memory and to said display screen controls the perceptible attributes of the graphical image of the virtual character in response to changes in the data stored in the cache memory.

In the preferred embodiment, the update messages transmitted via the wireless data network are contained in data packets from which the decoder extracts the selected current values that control the behavior of the virtual character. The wireless data transmission network is preferably selected from the group comprising the GSM, FLEX, reFLEX, control channel telemetry, FM or TV subcarrier, digital audio, satellite radio, WiFi, WiMax, and Cellular Digital Packet Data (CDPD) networks. Each of these networks transmits an update message that conforms to a standard data format normally employed by the given network. In the preferred embodiments, the same update message is transmitted in a one-way broadcast to many different display devices.

Alternatively, the virtual character may be implemented using the World Wide Web. Each state of the virtual character may be visibly represented by a web page transmitted from a conventional web server, and the state may be updated periodically by transmitting update web pages to represent new states. For example, a user may be asked to dress a virtual character using garments suitable for the weather in a specific zipcode.

The virtual character may be represented by physical character, such as animatronic stuffed animal, having perceptible behavior characteristics that are controlled by the combination of the users commands and the data from the remote source. Alternatively, the virtual character may be represented by a graphical image on a display screen, such as an LCD screen in which the graphical image consist of a mosaic of visual elements which are controlled by the processor.

In one preferred form, the virtual character is displayed on an LCD screen, or other screen having very low power requirements, that is housed in a stand-alone battery powered unit that includes a wireless receiver for acquiring the data from a remote source, one or more input devices for accepting commands or selections from a user, and a processor which processes the commands and the data from the remote source to vary the perceptible attributes of a displayed virtual character seen on the screen.

A particularly useful embodiment of the invention employs the receiver to acquire data from a remote source that provides information on local weather conditions, and the user employs pushbuttons or the like to select articles of clothing that the virtual character should wear that would be suitable for those weather conditions. If the user picks appropriate clothing, the displayed virtual character smiles, but if not, the virtual character frowns. Instead of simply showing a child the weather forecast, the interactive virtual character invites the child to participate and take ownership of the weather forecast. By dressing a virtual character in the appropriate wardrobe, to which the virtual character responds with a smile, a child is made more aware of the clothes he or she should be wearing, thereby reducing the supervision required by a parent.

These and other features and advantages of the present invention will be made more apparent by considering the following detailed description.

### BRIEF DESCRIPTION OF THE DRAWINGS

In the detailed description which follows, frequent reference will be made to the attached drawings, in which:

FIG. 1 is a block diagram of a prior art virtual character implemented as a state machine;

FIG. 2 is a block diagram of a virtual character of the kind shown in FIG. 1 but modified to accept and respond to additional content in real-time from a local or remote source.

FIG. 3 illustrates a virtual character embodying the invention displayed on an LCD screen in a keychain device that contains the control electronics;

FIG. 4 illustrates a different face displayed for the virtual character 311 in FIG. 3; and

FIG. 5 is a functional block diagram showing the principal functional components of the embodiment seen in FIG. 3.

### DETAILED DESCRIPTION

The preferred embodiments of the invention described below is a virtual character that includes some type of real-time information as part of the inputs to the character's state machine. For example, in addition to user input, randomness, clock, and other characters, the character's state is also determined by the current weather conditions and/or the current weather forecast. Continuing this example, if it is forecast to rain, the user might be required by the state machine to make sure the virtual character has shelter. If the user fails to provide shelter, the virtual character might get sick or suffer some other consequence.

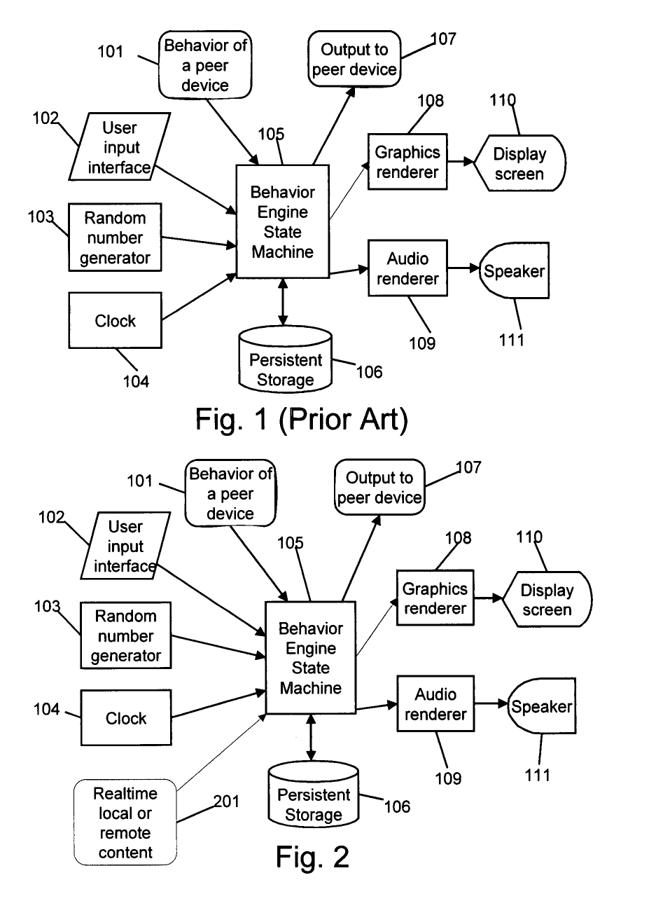

The conventional virtual character shown in FIG. 1 has been modified to include a real-time content source seen at 201 in FIG. 2. From the perspective of the state machine, this is simply another class of inputs. But a key difference is the state of these inputs is often well outside the control of the user. In the case of the virtual character communicating with other virtual characters (such as 101 and 107 seen in FIGS. 1 and 2), this input is also outside the control of any of these remote peer user's as well. In general, real-time content exists independent of the virtual character and is typically not generated for the purpose of influencing the behavior of the virtual character.

It is important to note this external real-time content from 201 can be received electronically via a wired or wireless connection, or by using a local sensor such as a barometer, hydrometer, thermometer, accelerometer, ammeter, voltmeter, light-meter, sound-meter, or other. In the case of electronic RF signal transmission, the content source can supplied be via a local wired or wireless link, or a long-range wireless link aggregated by servers as described in Application Publication 2003/0076369. Additionally, the user can be required to pay a one-time or recurring fee for this wireless content.

Additional content sources that could determine the behavior and state of the virtual character includes stock market performance, road traffic conditions, pollen forecasts, sports scores, and new headlines. These content sources can also be personal, such as email accumulation, personal stock portfolio performance, or Instant Messenger status of a loved one or co-worker. For example, a virtual dog could get excited or wake up from a nap when the instant messenger status of someone on the user's buddy list changes.

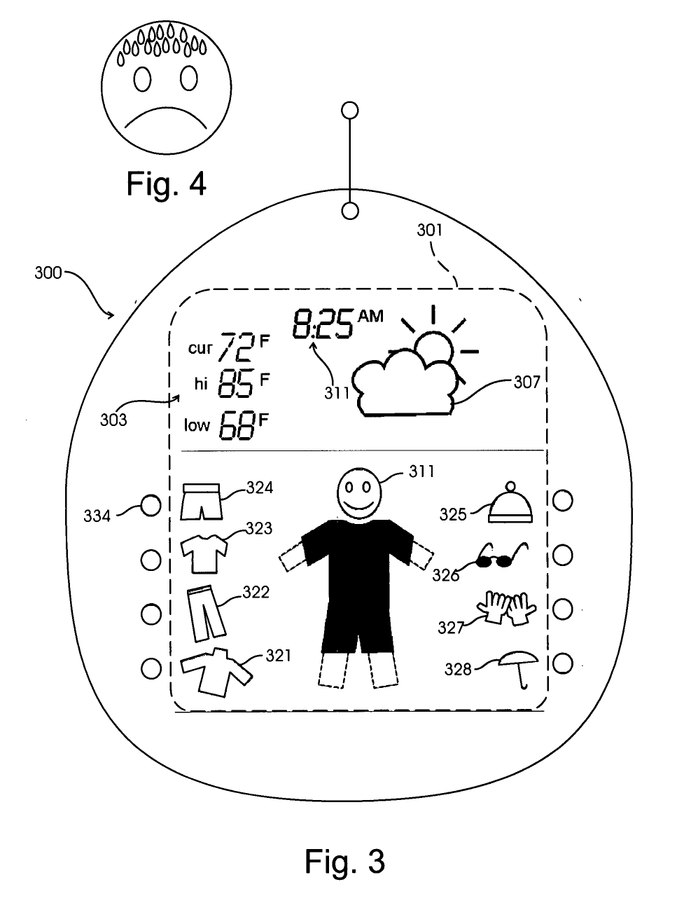

An illustrative embodiment of this invention is illustrated in FIG. 3. This is a keychain pet indicated generally at 300 that is similar to a Tamogatochi™, but the optimal user action depends in part on weather forecast data from a remote source. The keychain device 300 includes an LCD screen 301 that shows the weather forecast for the current day. The weather forcast data is obtained from a remote source in the manner described in the above-noted application Ser. No. 11/149,929. In the implementation shown in FIG. 3, the high, low, and current temperatures are shown at 303. The LCD screen also displays an icon at 307 representing the conditions for the day, and the current time is displayed at 311.

The icon 307 may represent one the following 16 states (encoded as four bits), requiring at total of 20 bits encodable as three bytes:

| Code | State |
|---|---|
| 0000: | blank |
| 0001 | Sunny |
| 0010 | Partly Cloudy |
| 0011 | Partly Cloudy Rain |
| 0100 | Partly Cloudy Snow |
| 0101 | Partly Cloudy Rain AM |
| 0110 | Partly Cloudy Snow AM |
| 0111 | Partly Cloudy Rain PM |
| 1000 | Partly Cloudy Snow PM |
| 1001 | Cloudy |
| 1010 | Cloudy Rain |
| 1011 | Cloudy Snow |
| 1100 | Cloudy Rain AM |
| 1101 | Cloudy Snow AM |
| 1110 | Cloudy Rain PM |
| 1111 | Cloudy Snow PM |

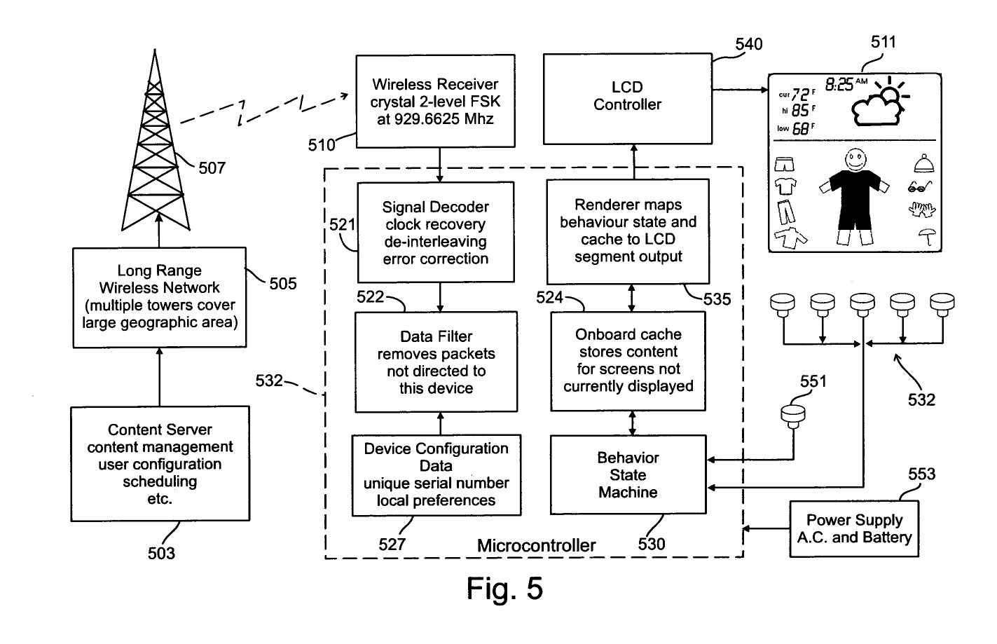

Note that these sixteen states are displayed by displaying combinations of the following visible elements, each of which consists of a pattern of segments which are rendered visible when the electrodes which form those segments are energized: (1) upper portion of sun icon, (2) lower portion of sun icon, (3) cloud icon, (4) rain icon, (5) snow icon, (6) “AM” letters, and (7) “PM” letters. Note that these icons could be directly controlled by 7 transmitted bits (for each of the five icons), or as noted above, by four bits for the sixteen possible states. Since the most valuable resource is the bandwidth of the broadcast signal, it is preferable to send 20 bits (4 bits for each of the five icons), and employ a microcontroller (seen at 532 in FIG. 5) to translate each four bit value into the corresponding seven control signal states applied to the LCD electrodes.

The data used to control the weather icon 307 is also used by the state machine to control the behavior of the virtual character. Thus, the states 0001 (sunny) and 0010 (partly cloudy) indicate that sunglasses would be an appropriate selection, whereas the data indicating rain makes the umbrella an appropriate selection as discussed below in connection with Table 1.

This weather forecast can come from a long-range tower network broadcasting web-configurable individual or broadcast data, from a short-range wired or wireless link to a temperature sensor, barometer, or similar transducer, or from an on-board temperature sensor, barometer, or similar transducer. As contemplated by the invention, remote or local data (such as the weather data and time displayed at the top of the LCD 301 in the illustrative embodiment of FIG. 3, is also supplied as input data to control the state machine that governs the behavior of the virtual character.

In the arrangement seen in FIG. 3, the user is required to dress the virtual character seen at 320 displayed on the bottom part of the screen 301. The user can choose any combination of shorts 321, a short-sleeved shirt 322, pants 323, a turtleneck sweater 324, a winter hat 325, sunglasses 326, gloves 327, or an umbrella 328. The user toggles whether or not the character is wearing a particular clothing item by pressing the button adjacent to that item, such as the button 334 adjacent to the image of the shorts at 324.

If the character is dressed appropriately, the face displays a smile as seen at 311. If the character is dressed incorrectly, it will frown. Additional cues will provide details about the nature of the inappropriate wardrobe choice. For example, if the character is too warm it will sweat and frown as illustrated in FIG. 4, and if the character is too cold it will shiver and/or show icicles hanging from facial features.

In this illustrative implementation, there are no long-term consequences to any pattern of correct or incorrect wardrobe choices. But a different implementation could easily add these features in order to make the interaction more compelling. The illustrative arrangement illustrated in FIG. 3 is a simple example of a virtual character that includes external real-time data as an input to the state machine, but arbitrarily complex characters and behaviors are readily implemented without changing the architecture of the system.

The preferred embodiment of the invention receives an information bearing contents signal that is simulcast to a plurality of devices, each of which is capable of producing a virtual character whose behavior depends in part on the content of the simulcast data and in part on selections made by the user of each particular device. Each virtual character presentation device includes a wireless receiver for detecting an information bearing signal broadcast by a transmitter and a processing means coupled to said receiver for converting said received data signal into a periodically updated content values, and for further processing the selection data accepted from the device user, to control the appearance or behavior of the virtual character.

In one arrangement, the transmitter and receiver respectively send and receive data packets via a radio transmission link which may be provided by an available commercial paging system or a cellular data transmission network.

The display panel 301 may present a mosaic of separately controlled visual elements is preferably formed by a flat panel display, such an LCD, an electronic ink panel, or an electrophoretic display panel, as described in more detail in the above-noted patent application Ser. No. 11/149,929. The individual visual elements of the display are energized or deenergized by the control signals. The reflectivity or visual appearance of each of the visual elements of display panel is controlled by one of said control signals, providing a display device that does not require a source of illumination and can accordingly be operated continuously consuming little electrical energy.

A functional block diagram is shown in FIG. 5. A content server seen at 503, such as the Ambient Network Server which is currently in operation, aggregates weather content from a weather forecasting service such as AccuWeather™ or the National Weather Service. This data is parsed into a terse format for efficient wireless broadcast via a long range wireless network seen at 505. A nearby one of the multiple broadcast towers seen at 507 broadcasts a data signal to the RF receiver seen at 510 located in the housing of keychain device that displays the virtual character on a display screen seen at 511. Each display unit for displaying a virtual character may be assigned a unique serial number that allows for targeted (narrowcast) broadcasts for various purposes including over-the-air reprogramming such that the device will additionally or exclusively decode data packets created exclusively for this specific or class of devices. This allows user to customize both the presentation of data, and the actual data display displayed on his or her device.

The weather forecast data may be broadcast to the display from the remote content server 503 via a commercial paging network or cellular data network. The weather data signal is simulcast from each of several transmission antenna illustrated at 507, one of which is within radio range of each display unit. The weather data itself may be obtained from a commercial weather service such those provided by AccuWeather, Inc. of State College, Pa.; The Weather Channel Interactive, Inc. of Atlanta, Ga.; and the National Weather Service of Silver Spring, Md.

At the server 503, the weather forecast data is encoded into “micropackets” and multiple micropackets are assembled for efficient delivery via a wireless data transmission network, such as a Flex™ type wireless pager system at 505. The encoded data packets can range in size between a single byte of data to several hundred bytes. The time-slice format used to transmit pages place an upper limit on the size of a paging packet. While there is no lower limit on packet size, small packets are inefficient to deliver. For example, in Flex™ paging systems, the overhead to transmit a single data packet ranges from 8 to 16 bytes. . Therefore, less bandwidth is used to send a single 100-byte data packet, than to send 20 5-byte data packets. Because the amount of data needed to provide a full weather forecast for a given location is approximately 25 bytes, several micropackets each of which provides forecast data for a different location may be aggregated into a single packet, and each remote ambient device 101 is configured to listen to, or receive, a specified segment of that packet including the expected micropacket of data. Additionally, smaller micropackets of a single byte can be used to update only the current temperature. The entire forecast does not need to be updated with the same periodicity as the current temperature because the above cited weather forecasting organizations only update their forecasts a small number of times per day. By dynamically sizing the update to only include data that has changed, even greater bandwidth savings can be achieved. Aggregation of the micropackets into packets of data for transmission is much more efficient than transmitting individual data packets to each individual remote ambient device. More sophisticated aggregation and scheduling approaches can, for example, take into account additional parameters such as how much the data has changed, how urgently the data needs to be updated, what level of service the user is entitled to, and what type of coverage is available to the user. See the above noted U.S. Patent Application Publication 2003/0076369 for additional details.

As also discussed in detail in Publication 2003/0076369-A1, the server 503 may provide a web interface that permits a user or administrator to configure the content and format of the data broadcast to the remote display units for different applications and special needs of individual users. The user or administrator may configure the system using a conventional web browser program executing on a PC which is connected via the Internet to a web server process that runs on the server 503 or a connected server.

Each virtual character rendering device incorporates a data receiver 510 for receiving the wireless radio broadcast signal from a nearby transmission antenna 507 and a microcontroller 532 for processing the incoming packetized data signals from the receiver 510 and converting those packetized signals into control signals that are delivered via display driver circuitry 540 to an LCD display panel 511. The microcontroller 531 may accumulate data transmitted at different times in a cache store 524 which may hold enough weather forecast data to permit several different display modes to be selected at the display panel.

The transmission system, as described above, provides a continuous display of information. At any given time, some of the displayed information may change very infrequently whereas other portions of the display may change only on a daily basis (such as the high and low temperature values for the day), and still other portions of a display may change often (such as the current temperature of “72°” in the display seen in FIG. 5). By sending data defining the new state of only those portions of the display that change, when they change, a significant bandwidth saving is achieved. In addition, the transmission facility may be used to download executable code or over-the-air (OTA) reprogramming instructions to a specific device on an as needed basis. Thus, when a user selects a new service or display format using a Web interface or by some other means, new data and/or software may be directed to that device. In this way, new screen layouts, new symbols or icons, and the like may be transmitted to a specific device to alter its function whenever the user changes his preferences, or changes to a different service (perhaps a premium service which is billed at a different subscription rate), or a when an existing service is updated or improved (perhaps transparently to the user). As described in the above noted U.S. Patent Application Publication 2003/0076369-A1, a sub-addressing operation may be used to transmit specific data to a specific display device.

Each display device may be assigned a unique ID which is stored locally on the device. Broadcast packets preceded by this unique ID are decoded by the device, while other devices with different unique ID are discarded. By transmitting a particular service code or codes to a particular device or group of cloned devices which defines the kind of service that device subscribes to (e.g. a nine-day forecast for Boston), the display device can be conditioned to thereafter look for and respond to packets relating to that designated service. The transmitted data to which the device responds include not only displayable data, but also mapping data and software which determine how the device renders the received data on the display screen.

Note that individually addressing each device can also be accomplished by assigning each device a unique “capcode” which is obtained from the paging network operator. In some situations this may have certain advantages for battery optimization, but it requires greater coordination between the server operator and the paging network operator. Note also that any scheme which uses an explicit address (either subaddressing or unique capcode) to send a packet a particular device or devices is only used for the reprogram instructions and code, which are typically infrequent and in practice are a very small percentage of the bandwidth budget. The actual data is broadcast using a “micropacket” scheme described above and in U.S. Patent Application Publication 2003/0076369-A1. This micropacket scheme is much more efficient at transmitting small amounts of data typically employed with the devices described in this application. The Flex™ paging system which may be used to transmit data to the devices is divided by the paging network operator into 63 “simulcast zones”. In this way, a single simulcast zone acts like a large distributed antenna, which greatly increases coverage by filling in dead spots. Simulcast zones are arranged such that there is minimal overlap between adjacent simulcast zones. This ensures that any given device only receives signal from a single simulcast zone.

The raw FSK signal from the receiver 510 is fed into a data port of the microcontroller 512, a Microchip™ PIC 18LF252 chip, for decoding. The first step of this decoding is clock recovery, de-interleaving, and error correction performed by the microcontroller 512 as indicated at 521. A data filter 522 listens for and extracts content appropriate for this particular device. The desired content appropriate for this device is decoded and stored in an onboard data cache 524. A behavior state machine 530 combines this incoming, decoded weather forecast data with the user input data supplied by the pushbuttons seen at 532 to determine if the virtual character displayed on the screen 511 is to smile or frown, and adds any other modifiers to the character's state such as sweat or ice. This screen content data also stored in the onboard cache 524. A renderer 535 maps the state machine to LCD segments and drives an LCD controller 540, which physically connects to the custom LCD screen 511.

This embodiment also includes a reset button 551 to erase any state, and a power supply 553, which can be AC powered, battery powered, or both.

Table 1 below shows a state table for each article of clothing and accessory along with the appropriate forecast and/or current conditions:

TABLE 1

| | Forbidden | Mandatory | |
|---|---|---|---|
| | Weather | Weather | Out of range |
| Item | Conditions | Conditions | response |
| Shorts | Below 50 degrees | Above 90 degrees | Shiver/sweat |
| Short-sleeved | Below 50 degrees | Above 90 degrees | Shiver/sweat |
| shirt | | | |
| pants | Above 90 degrees | Below 50 degrees | Shiver/sweat |
| Turtleneck shirt | Above 80 degrees | Below 40 degrees | Shiver/sweat |
| Winter hat | Above 60 degrees | Below 40 degrees | Shiver/sweat |
| sunglasses | Any precipitation | Part cloudy, sunny | Squint/ |
| | | | disoriented |
| gloves | Above 60 degrees | Below 40 degrees | Shiver/sweat |
| umbrella | No precipitation | Any precipitation | Wet/awkward |

Every time there is a change in the state data supplied by the user interface (that is, a change in the selection of items, the state machine compares each article of clothing and accessory to a state table and makes the following determinations:
(1) Does the forecast weather mandate this article be included?
(2) Does the forecast weather mandate this article NOT be included? If any clothing or accessory is inappropriate for the forecast, the character will frown and display additional cues about the nature of the dissatisfaction. If all clothing and accessories are appropriate, the character will smile.

The following conditions and results are examples inferred from Table 1;
a) If character is dressed in shorts and forecast temperature is below 50 degrees, the character will shiver and frown.
b) If character is dressed in winter doting at and temperature is above 60 degrees, the character will sweat and frown.
c) If character is carrying an umbrella but there's no forecast, the character will have an awkward or silly facial expression and frown.
d) If character is NOT carrying an umbrella and there is forecast rain, the character will appear wet and frown.
e) If character is wearing sunglasses and it's not sunny or part cloudy, the character will appear disoriented and frown.
f) If character is NOT wearing sunglasses and it's sunny or part cloudy, the character will squint and frown.

It is possible for the character to display multiple negative emotions—for example the character can shiver and be wet if it's forecast to be cold and rainy, and the character is wearing shorts and no umbrella. Note that, from Table 1, if the forecast temperature is exactly 60 degrees, any article of clothing is considered appropriate.

### Other Illustrative Embodiments

The embodiment illustrated in FIG. 1 renders the virtual character as a graphical image on a display screen, but the virtual character take other forms, such a physical object like a plush animal. The user is required to dress the animal appropriately for the current weather forecast. RFID tags embedded in the clothes may be detected by sensors in the animal so that a determination can be made as to what clothes the animal is wearing. This wardrobe information is fed to the state machine. Similar to the embodiment in the previous example, the overall happiness of the character is determined by manner in which the user has dressed it. The difference between this example and the former example is the former is rendered on an electronic display, while the latter uses a physical doll and physical clothes. Happiness and sadness with wardrobe can be shown with motors controlling eyelids and other facial expressions, and a vibrating motor can reproduce shivering while a sound chip can create the sound of panting. Or a sound chip could simply render speech with snippets such as “I'm too hot” or “I'm too cold”.

Another illustrative embodiment might employ the weather forecast for a pre-determined geographical region to control the interaction between a user and an online pet. For example, NeoPets™ described above could act differently if the weather forecast shows rain in the region where the user lives. Or to use the example of “Dress Elmo”, instead of using a small number of pre-determined weather scenarios, the user would be required to dress Elmo according to the actual weather report for where the user lives. This would entice children to visit the website every day not only to learn what the weather is, but to make sure Elmo is wearing the correct clothing.

Similar interactions can be created for other content sources as outlined in Table 2 below:

TABLE 2

| Data Content | Interaction |
|---|---|
| Pollen forecasts | Dosage of anti-allergy medication to virtual character. |
| | Character responds by being drowsy (too much |
| | medication), sneezy (too little medication) or |
| | happy (just right) |
| Traffic | What time character needs to leave for work. |
| Sports | Performance of user's “fantasy” team against |
| | actual sports performances |
| Stocks | Performance of user's “fantasy” stock portfolio against |
| | actual stock performance. |
| Fishing | User must choose appropriate bait and times for fishing |
| | based on actual current and forecast parameters affecting |
| | fishing conditions. |

As described in the above noted Application Publication No. 2003/0076369 and application Ser. No. 11/149,929, the centralized server can reprogrammed dynamically to supply different content. This allows the user to change the content source (e.g stock market), or modify parameters of the content (e.g. contents of stock portfolio). Some data feeds may be associated with a recurring or one-time fee. Additionally, the ability for the virtual character to respond to the content may also be monetized. Signals sent from the server determine the permissions the device has to decode certain signals and/or unlock certain features.

Consumer Behavior

One goal of this invention is to allow the user to create an emotional bond with the virtual character by participating in its care in a way that is also relevant to the “real” world. The various forms of virtual characters are very popular, and this invention is intended to make them more relevant by including actual real-time data that impacts the behavior of the non-virtual user. By including behaviors that respond to real-time content, the user experience of interacting with a virtual character will be even more compelling and enjoyable.

A more specific goal of the weather responsive embodiment described above is to help children dress appropriately for the day. Instead of simply showing a child the weather forecast, this invites the child to participate and take ownership of the weather forecast by dressing a virtual character in the appropriate wardrobe. This activity makes the child more aware of the clothes he or she should be wearing, and thereby reduce the supervision required by a parent.

Although the preferred embodiment described in connection with FIGS. 3-5 use weather data to control the virtual character, all kinds of content can be used as inputs to the virtual character's state machine. The examples disclosed here all have a virtual character as the entity receiving input from the content source. But this disclosure applies to the insertion of real-time content anywhere in the virtual world—for example if it is raining in the “real” world, it is also raining in the virtual world, and this virtual rain will have an effect on the character.

In many ways, this interaction is best understood by considering the weather as being another virtual character that interacts with other virtual characters in the same way that the peer character seen at 101 in FIGS. 1 and 2 influences the behavior of other virtual characters. This “environmental” character receives real-time inputs that affects its state machine. This in turn affects the outputs from this environmental character, which affects the inputs of more traditional virtual characters.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. In an interactive system of the type including an input device for accepting input command data from a user and a display screen for producing a graphical image representing a real or imagined human or animal whose displayed behavior varies in response said input command data, the improvement comprising:
a data transmission network for repetitively broadcasting update messages that contain the current values of one or more variable quantities, said update messages being broadcast to a plurality of different wireless data receivers each of which is located remotely from said information server and each of which includes a data receiver including a decoder for receiving said update messages and for extracting selected ones of said current values from said update messages,
a cache memory coupled to said input device and to said decoder in one of said data recievers for storing said input command data and said selected ones of said current values extracted form said update messages, and
a processor coupled to said cache memory and to said display screen for controlling the perceptible attributes of said graphical image in response to changes in the data stored in said cache memory.

2. The improvement as set forth in claim 1 wherein said update messages are contained in data packets transmitted via a wireless data transmission network.

3. The improvement as set forth in claim 2 wherein one or more of said data packets are designated by a unique identification code and wherein decoder extracts said selected ones of said current values form said data packets identified by said unique identification code.

4. The improvement as set forth in claim 1 said wireless data transmission network is selected from the group comprising the GSM, FLEX, reFLEX, control channel telemetry, FM or TV subcarrier, digital audio, satellite radio, WiFi, WiMax, and Cellular Digital Packet Data (CDPD) networks.

5. The improvement as set forth in claim 1 wherein said wireless data transmission network comprises a one-way wireless paging transmission system and wherein said update messages conform to a standard data format normally employed by said wireless paging transmission system.

6. The improvement as set forth in claim 1 wherein said wireless data transmission network comprises any one-way broadcast one-to-many system such as control channel telemetry, GSM cell broadcast, FM or TV subcarrier, digital audio, or satellite radio, and wherein said update messages conform to a standard data format normally employed by that system.

7. An interactive system for controlling a virtual character that represents the attributes of a real or imagined human or animal comprising, in combination:
a receiver for receiving an information bearing signal broadcast from a remotely located information source via a wireless data transmission network,
a decoder for extracting variable data from said information bearing signal,
one or more input devices for accepting command data from said user,
a rendering device for presenting said attributes of said real or imagined human or animal in a form perceptible to said user, and
a processor coupled to said wireless receiver and to said decoder for controlling said rendering device to vary said attributes in response to changes in said command data from said user and in response to changes in said variable data from said decoder.

8. An interactive system for controlling a virtual character as set forth in claim 7 wherein said information bearing signal is comprises data packets transmitted via a wireless data transmission network.

9. An interactive system for controlling a virtual character as set forth in claim 8 wherein wireless data transmission network is a radio paging system.

10. An interactive system for controlling a virtual character as set forth in claim 8 wherein said wireless data transmission network is a cellular telephone network.

11. An interactive system for controlling a virtual character as set forth in claim 9 wherein one or more of said data packets are designated by a unique identification code and wherein said decoder extracts said variable data from data packets designated by said unique identification code.

12. An interactive system for controlling a virtual character as set forth in claim 7 wherein said rendering device is a display screen for presenting said attributes of a real or imagined human or animal character as a visual graphical image perceptible to said user.

13. An interactive system for controlling a virtual character as set forth in claim 12 wherein said display screen presents said virtual character as a mosaic of separately controlled non-uniform visual elements whose appearance is controlled by controlled b said processor.

14. An interactive system for controlling a virtual character as set forth in claim 13 wherein said display screen is a liquid crystal display panel for displaying a mosaic of visual elements representing said attributes.

15. An interactive system for controlling a virtual character as set forth in claim 8 wherein said wireless data transmission network is selected from the group comprising the GSM, FLEX, reFLEX, control channel telemetry, FM or TV subcarrier, digital audio, satellite radio, WiFi, WiMax, and Cellular Digital Packet Data (CDPD) networks.

16. An interactive system for controlling a virtual character as set forth in claim 7 wherein said interactive system including said receiver, said decoder, said input devices, said rendering device and said processor are powered by one or more batteries such that said system is portable requires no external wired connections to power or data sources.

17. An interactive system for presenting a virtual human or animal character to a user whose behavior is dependent on information received from a remote source comprising:
an information source for supplying digital data in a predetermined format representative of one or more current values of one or more corresponding variable quantities,
a wireless data transmission network for repetitively simulcasting said current values in one or more update messages to a plurality of different wireless data receivers each of which is located remotely from said information server, at least one of said wireless data receivers including a decoder for receiving said update messages and for extracting said one or more current values from said update messages,
an input device for accepting one or more selection values from said user,
a display unit comprising a controllable representation of said human or animal character and a controller coupled to said decoder and responsive to said one or more current values and to said one or more selection values for varying perceptable attributes of said representation in response changes in said one or more current values and said one or more selection values.

18. An interactive system as set forth in claim 17 wherein said wireless data transmission network is selected from the group comprising the GSM, FLEX, reFLEX, control channel telemetry, FM or TV subcarrier, digital audio, satellite radio, WiFi, WiMax, and Cellular Digital Packet Data (CDPD) networks.

19. An interactive system as set forth in claim 17 wherein said wireless data transmission network comprises a one-way wireless paging transmission system and wherein said update messages conform to a standard packet format normally employed by said wireless paging transmission system.
